(19) United States
(12) Patent Application Publication
(10) Pub. No.: US 2025/0103096 A1
(43) Pub. Date: Mar. 27, 2025

(54) Head-Mounted Devices with Counterweights

(71) Applicant: Apple Inc., Cupertino, CA (US)

(72) Inventors: James T. Smith, Issaquah, WA (US); Jered Singleton, Bainbridge Island, WA (US); John S. Camp, Los Gatos, CA (US); Venkata Narayana Murthy Arelekatti, Mountain View, CA (US)

(21) Appl. No.: 18/435,845

(22) Filed: Feb. 7, 2024

Related U.S. Application Data
(60) Provisional application No. 63/584,222, filed on Sep. 21, 2023.

(51) Int. Cl. G06F 1/16; F16D 7/02

(52) U.S. Cl. CPC G06F 1/163; F16D 7/02

(57) ABSTRACT

A head-mounted device may include optical assemblies for presenting images to a user. The optical assemblies may be mounted in a head-mounted device housing. The head-mounted device housing may be supported at the front of the head of a user in front of the user's eyes using head-mounted support structures such as straps. The straps may include a rear strap and an overhead strap. A counterweight may be provided at the rear of the user's head to counterbalance the weight of the head-mounted device housing. The counterweight may be coupled to a rigid portion of the head-mounted housing at a connection. A clutch may be provided to allow the rotational orientation of the counterweight to be adjusted about the connection. A sliding mass in the counterweight may also be adjusted. These adjustments alter the amount of counterbalancing created by the counterweight to counterbalance the head-mounted device housing.

This application claims the benefit of provisional patent application No. 63/584,222, filed Sep. 21, 2023, which is hereby incorporated by reference herein in its entirety.

### FIELD

This relates generally to electronic devices, and, more particularly, to electronic devices such as head-mounted devices.

### BACKGROUND

Electronic devices have components such as displays and lenses. Straps may be used to help hold electronic devices such as head-mounted devices on the heads of users.

### SUMMARY

A head-mounted device may include optical assemblies for presenting images to a user. Each optical assembly may have a display and a lens. The optical assemblies may be mounted in a head-mounted device housing. Additional components such as sensors, input-output devices, fans, optical assembly positioning systems, and other components may be mounted in the housing.

The weight of the housing tends to pull downwardly at the front of the user's head. To counterbalance this downward force at the front of the user's head, the head-mounted device may be provided with a counterweight at the rear of the user's head.

The head-mounted device housing may be worn on the user's head using head-mounted support structures such as straps. The straps may include a rear strap and an overhead strap. The counterweight at the rear of the user's head helps to counterbalance the weight of the head-mounted device housing and helps distribute the downward force of the head-mounted device to the overhead strap evenly between front and rear.

The head-mounted housing may have an elongated rearwardly extending rigid portion. The counterweight may be removably coupled to the rigid portion of the head-mounted housing at a detachable connection. A clutch may be provided to allow the rotational orientation of the counterweight to be adjusted about the connection. A sliding mass in the counterweight may also be adjusted. These adjustments may be used to adjust how much counterbalancing force is created by the counterweight to counterbalance the head-mounted device housing.

### BRIEF DESCRIPTION OF THE DRAWINGS

FIG. 1 is a side view of an illustrative head-mounted device on a head of a user in accordance with an embodiment.

FIG. 2 is a perspective view of a rear portion of an illustrative head-mounted device having a counterweight in accordance with an embodiment.

FIGS. 3 and 4 are side views of portions of an illustrative head-mounted device showing how counterweights may be removably attached to the device in accordance with embodiments.

FIG. 5 is a side view of an illustrative integrated overhead strap and counterweight in accordance with an embodiment.

FIG. 6 is a side view of an illustrative counterweight without an integral overhead strap in accordance with an embodiment.

FIG. 7 is a side view of an adjustable counterweight with a sliding mass in accordance with an embodiment.

FIG. 8 is a diagram of a portion of an illustrative counterweight with optional components in accordance with an embodiment.

FIG. 9 is a side view of an illustrative head-mounted device with a counterweight and electronic ports for handing data and/or power in accordance with an embodiment.

FIG. 10 is a top view of an illustrative head-mounted device in which a counterweight has been rotated to serve as a rear cover for the head-mounted device in accordance with an embodiment.

FIGS. 11, 12, and 13 are top views of illustrative counterweight arrangements for a head-mounted device in accordance with an embodiment.

FIG. 14 is a side view of an illustrative counterweight attachment mechanism for a head-mounted device in accordance with an embodiment.

FIG. 15 is a side view of an illustrative head-mounted device showing how an adjustable counterweight can serve as an adjustable stand in accordance with an embodiment.

FIG. 16 is a side view of an illustrative head-mounted device in which a rear strap has been provided with counterweight functionality in accordance with an embodiment.

FIG. 17 is a side view of an illustrative head-mounted device with a front-to-back overhead strap and counterweight in accordance with an embodiment.

### DETAILED DESCRIPTION

Head-mounted devices may have housings that are supported on a user's head using support structures such as straps. A head-mounted device may have a housing that rests against the front of a user's head in alignment with the user's eyes during use. This allows displays in the housing to present images to the user. The weight of the displays and other components in the housing tends to pull downwardly on the front of a user's head. To counterbalance this force, the head-mounted device may be provided with a counterweight. During use of the head-mounted device, the counterweight in the head-mounted device may pull downwardly on the rear of the user's head with a force that counterbalances the downward force exhibited by the housing at the front of the user's head. In this way, the use of a counterweight may help enhance comfort.

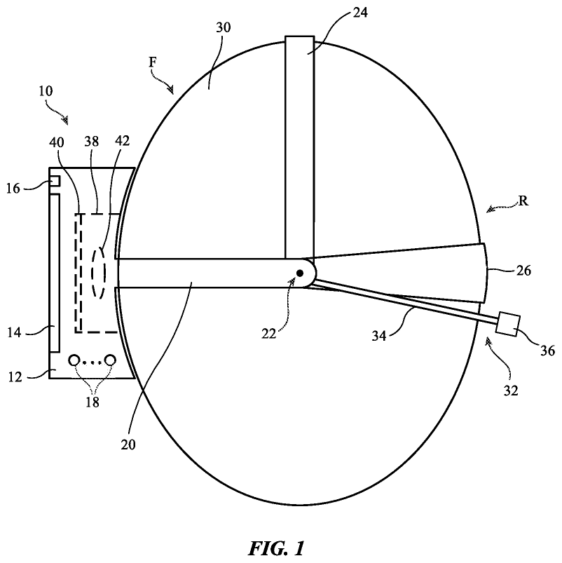

A side view of an illustrative head-mounted device with a counterweight is shown in FIG. 1. As shown in FIG. 1, head-mounted device 10 may have a housing such as housing 12 Housing 12 may be worn on front F of a user's head such as head 30. Straps such as overhead strap 24 and rear strap 26 at rear R of head 30 may be used to help hold housing 12 in place on head 30.

Housing 12 may contain a forward-facing display such as display 14 (e.g., a three-dimensional display having lenticular lenses overlapping an array of display pixels), sensors such as forward facing cameras 16, and other components 18 (e.g., control circuitry such as microprocessor circuitry, storage, application-specific integrated circuits, sensors, speakers, an optional battery, etc.). Left and right optical assemblies 38 (sometimes referred to as optical modules) may be used to display images in eye boxes. When a user's eyes are located in the eye boxes, left and right displays 40 and corresponding left and right lenses 42 in optical assemblies 38 may present images to the user (e.g., computer generated images, real-life images captured with cameras 16, and/or other content).

Head-mounted housing 12 may have rigid portions (e.g., a polymer shell, a glass cover layer over display 14, metal frame structures, and rigid structures formed from combinations of polymer, ceramic, glass, metal, and/or other rigid materials). These rigid structures may include elongated rigid housing extensions such as extension 20 (sometimes referred to as a power strap, elongated rigid housing portion, rigid strip-shaped extension, rigid extension, rigid strip, or rigid strap portion). Extension 20 may be rigidly attached to and/or integrated with the body of housing 12 at front F of head 30 and may extend rearwardly past the ears of the user towards connection 22. Connection 22 may, if desired, have a first part that is rigidly attached to extension 20 and a second part that is carried on removable items such as straps and/or a counterweight. Straps and counterweight structures may be attached to extension 20 at connection 22 and/or elsewhere along the length of extension 20.

In the example of FIG. 1 device 10 has an overhead strap such as strap 24. Strap 24 may have a narrow strip shape or a wider shape that extends over most or all of the top of head 30. Strap 24 may be removably attached to connection 22. During use of device 10, strap 24 may help bear some of the weight of device 10 on the top of the user's head.

Device 10 may, if desired, have a rear strap such as strap 26. Strap 26, which may sometimes be referred to as a rear-of-head strap or horizontal strap, may be formed from a stretchy material (e.g., stretchable fabric and/or elastic materials) and/or may be partly or entirely formed from rigid materials. During use of device 10, strap 26 may hug rear R of head 30 to help hold device 10 on head 30.

To counterbalance the weight of housing 12 at front F of head 30, device 10 may be provided with a counterweight at rear R of head 30. In the example of FIG. 1, counterweight 32 of device 10 has been rigidly attached to extension 20 at connection 22. Counterweight 32 may, if desired, be detachable (e.g., by a user). Removably attached counterweight structures may be removed from device 10 by a user when a user is resting their head on a pillow, when a user is donning or doffing device 10, or when the counterweight is otherwise temporarily not desired.

Counterweight 32 may also be adjusted by a user to adjust the amount of counterbalancing that is produced. For example, a user may reposition a repositionable mass within the counterweight to adjust how much counterweight torque is applied to connection 22 and therefore adjust the strength of the counterweight effect (sometimes referred to as the counterbalancing effect). The amount of counterbalancing that is produced affects how much the counterweight counteracts the downward force produced by the weight of housing 12 at the front of head 30. Because counterweight 32 may be removably attached to device 10 and may be adjusted in position and/or strength, counterweight 32 may sometimes be referred to as an adjustable counterweight, removable counterweight, adjustable detachable counterweight, etc. In the example of FIG. 1, counterweight 32 has a first portion such as wire 34 (sometimes referred to as an elongated support, elongated support structure, support, etc.), and a second portion such as movable mass 36 (sometimes referred to as a mass element, weight element, weight, counterweight, counterweight mass, etc.). Mass 36 may be formed from polymer, metal (e.g., one or more heavy metals such as brass, tungsten, etc.), and/or other materials. The weight of mass 36 may be at least 100 grams, at least 250 grams, at least 500 grams, at least 1 kg, less than 1 kg, less than 750 grams, less than 300 grams, or less than 150 grams or any other suitable weight that allows mass 36 to provide a desired counterweight force. Wire 34 is preferably sufficiently rigid to resist bending as mass 36 pulls downwardly on the end of wire 34.

During use of device 10, a user may slide wire 34 into and out of a channel within mass 36 to adjust the distance between mass 36 and connection 22. Connection 22 is supported by overhead strap 24, so movement of mass 36 along wire 34 adjusts the lever arm produced by mass 36 on connection 22. This adjusts how much counterbalancing torque is produced at connection 22. When mass 36 is moved closer to connection 22, the lever arm of counterweight 34 is shortened and the counterweight effect is decreased. When mass 36 is moved farther from connection 22, the lever arm of counterweight 34 is increased and the counterweight effect is increased. In this way, the user may make adjustments to ensure that the forward-rear balance of device 10 is comfortable for the user.

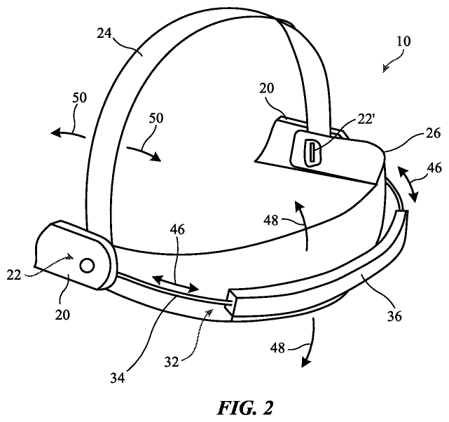

FIG. 2 is a rear perspective view of a rear portion of device 10. As shown in FIG. 2, connections 22 may be formed on the left and right sides of device 10. Connections 22 may have interlocking parts (snaps, etc.) and/or other structures that facilitate removable attachment of a strap, counterweight structure, or other component to extension 20. As shown by portion 22′ of connection 22, each connection 22 may be provided with structures (e.g., flat surfaces) that allow mating structures to apply torque to connection 22 and the extension 20 associated with that connection 22 without slipping.

When a user desires to adjust counterweight 32, the user may slide wires 34 on the left and right into and out of mass 36 so that position of mass 36 may be shifted forwardly or rearwardly as shown by arrows 46. Counterweight 32 may be rigidly attached to connection 22 (e.g., so that counterweight 32 cannot rotate about connection 22 with respect to extension 20), may be rotatably attached at connection 22 using a rotational clutch (e.g., a friction clutch, a clutch with angled protrusions or other structures that create rotational detents, etc.), may be attached using a user-adjustable screw or other user-adjustable connection, or may be attached using other connection structures that allow the rotational position of counterweight 32 about connection 22 to be adjusted during a first mode (sometimes referred to as a rotational adjustment mode) and then subsequently fixed in place (to apply counterweight torque to extension 20) during a second mode (sometimes referred to as a use mode or non-rotating counterweight use mode). The optional ability of counterweight 32 to be rotationally positioned by the user about connection 22 is shown by arrows 48. Overhead strap 24 may likewise be attached to connection 22 in a non-rotating fashion or using a clutch or other mechanisms that allows the rotational position of strap 24 about connection 22 to be adjusted, as shown by arrows 50. The ability of counterweight 32 to be rotatably positioned about connection 22 allows counterweight 32 to be rotated up and out of the way (e.g., to a position over strap 24) when desired (e.g., when rear R of head 30 is resting on a pillow, when device 10 is being removed or placed on head 30, etc.).

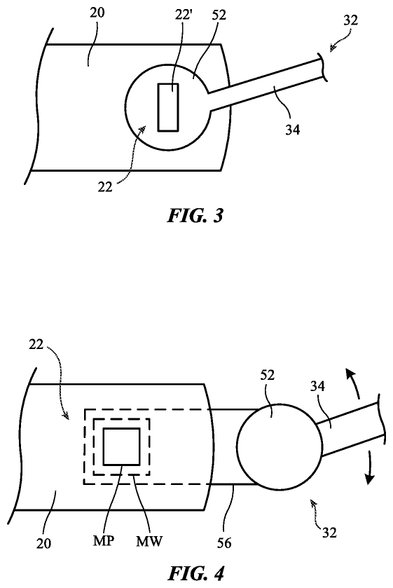

Illustrative arrangements that allow the rotational orientation of counterweight 32 about connection 22 to be adjusted are shown in FIGS. 3 and 4. In the example of FIG. 3, portion 22′ of connection 22 is rigidly (non-rotatably) attached to extension 20 and has flat sides that securely (and non-rotatably) engage clutch 52. Clutch 52 is coupled between connection 22 and wire 34 of counterweight 32. Using clutch 52 (which may sometimes be referred to as a rotational adjustment clutch), the rotational orientation of counterweight 32 about connection 22 may be adjusted by a user. Following user adjustment of the rotational orientation of counterweight 32, clutch 52 provides sufficient rotational resistance to transfer torque from counterweight 32 to connection 22 and thereby transfer torque to extension 20 to counteract the downward force from housing 12.

In the example of FIG. 4, connection 22 uses magnetic attraction. Counterweight 32 has a rigid portion such as portion 56 that has a first magnet MW. Magnet MW is magnetically attracted to corresponding magnet MP of extension 20. Due to magnetic attraction between magnets MW and MP, portion 56 is non-rotatably coupled to extension 20. Clutch 52 couples wire 34 of counterweight 32 to portion 56 and thereby allows the rotational orientation of counterweight 32 to be adjusted by a user. If desired, clutch 52 may be omitted (e.g., in a scenario in which the rotational position of counterweight 32 is not adjustable).

Mounting arrangements based on friction fits, snaps, adjustable-friction connections (e.g., mating pads secured by screws), and/or other attachment mechanisms may be used to attached counterweight 32 to extensions such as extension 20 (with or without using clutches such as clutch 52). The examples of FIGS. 3 and 4 are merely illustrative.

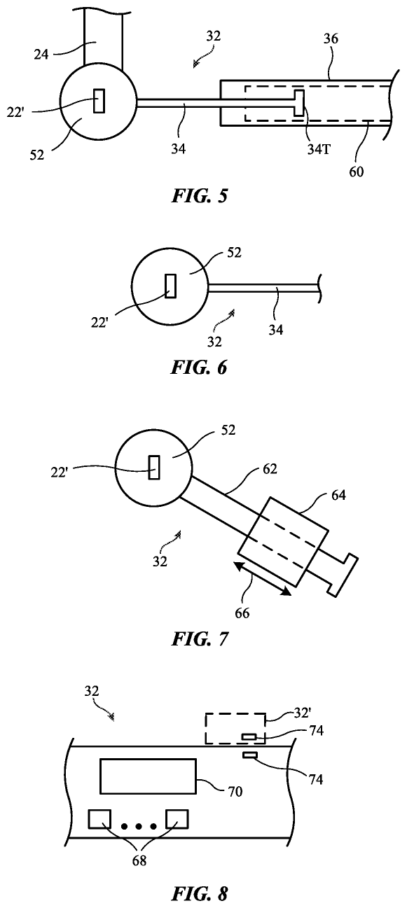

As shown in FIG. 5, strap 24 and counterweight 32 may be integrated into a single accessory. A single removable and adjustable unit may, for example, be formed by attaching wire 34 and strap 24 to clutch 52. Wire 34 may slide within channel 60 of mass 36 to adjust the forward-backward position of mass 36. Tee-shaped end 34T of wire 34 may be used to prevent wire 34 from being pulled out of mass 36.

As shown in FIG. 7, counterweight 32 may have an elongated support structure such as shaft 62 or other elongated member attached to clutch 52. (e.g., a tubular shaft formed from polymer, metal, and/or other materials) rather than wire 34. In this type of arrangement, counterweight 32 may be provided with a counterweight mass that slides along the length of shaft 62 in directions 66 such as slidable mass 64. Mass 64 may slide along shaft 62 with sufficient friction to prevent mass 64 from slipping once the user has finished adjusting the position of mass 64. When mass 64 is moved towards clutch 52, the lever arm effect produced by mass 64 is reduced, whereas when mass 64 is moved away from clutch 52, the lever arm effect produced by mass 64 is increased. In this way, a user may adjust the impact of counterweight 32 on the forward-rear balance of device 10.

FIG. 8 shows how counterweight 32 may contain an optional battery 70 and/or other components 68 (e.g., a speaker, a camera such as a rearward-facing or sideways facing camera, a haptic device such as an electromagnetic actuator that vibrates and/or creates other haptic output, audio processing circuitry, control circuitry, display processing circuitry, sensors, light-emitting devices, and/or other components). If desired, counterweight 32 may have a user-detachable portion such as removable portion 32′. Magnets 74 or other detachable attachment mechanism may be used to removably attach portion 32′ to counterweight 32. Optional battery 70 and/or other component(s) 68 may be mounted in portion 32′, if desired. Wireless and/or wired connections may be used to route power and/or data between counterweight portion 32′ and other portions of counterweight 32 and/or may be used to route power and/or data between counterweight 32 and other portions of device 10.

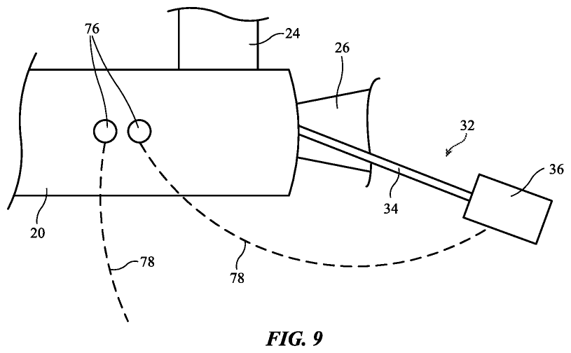

FIG. 9 shows how extension 20 may be provided with one or more ports 76 (e.g., data and/or power ports). Components (e.g., components 68 of FIG. 8 and/or battery 70 of FIG. 8) may be mounted in mass 36 or other structures in counterweight 32 and may supply power and/or data to the components of housing 12 via one of ports 76 and one of cables 78. One of the cables 78 plugged into ports 76 may also be used to receive power and/or data from an external battery pack and/or an external data source.

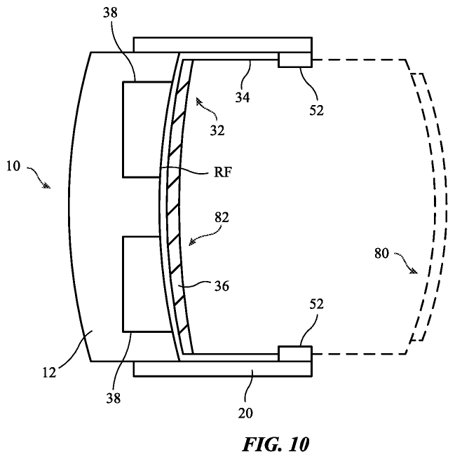

If desired, mass 36 and/or other portions of counterweight 32 may be configured to serve as a rear cover for housing 12 (e.g., mass 36 may be configured to form a curved sheet that fits over optical assemblies 38 at the rear of housing 12). As shown in FIG. 10, counterweight 32 may be rotated about clutch 52. In rear position 80, mass 36 may serve as a counterweight mass to help balance out the weight of housing 12. When moved to front position 82, mass 36 serves as a protective dust cover that covers and seals the otherwise uncovered inwardly facing portions of assemblies 38. In this way, dust and other undesired contamination may be prevented from entering assemblies 38.

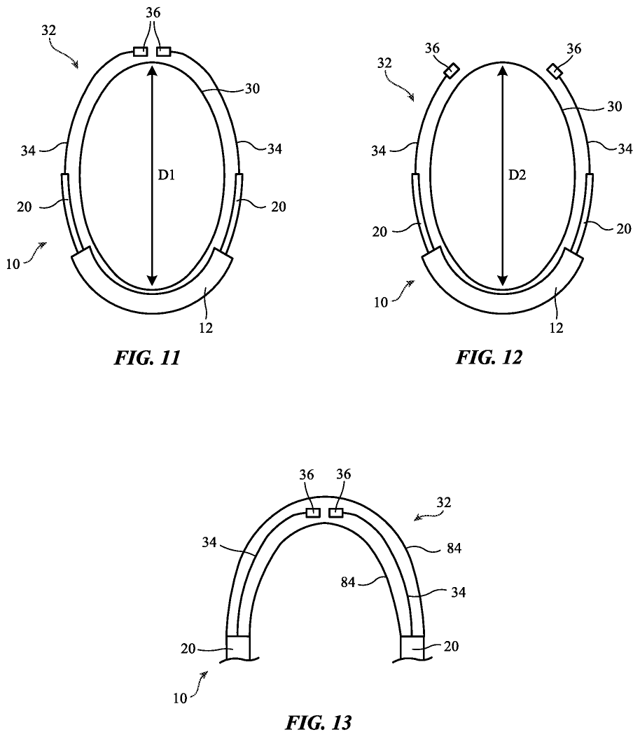

In the illustrative configuration of FIGS. 11, 12, and 13, counterweight 32 is configured to provide satisfactory counterweight performance to users with different head sizes. As shown in FIG. 11, counterweight 32 has two masses 36 coupled to the ends of wires 34. The user of FIG. 11 has a smaller head 30 characterized by smaller distance D1 between the front and rear of the head. In this arrangement, wires 34 curve so that masses 36 are placed at a satisfactory distance to counterbalance the weight of housing 12. When counterweight 32 of device 10 of FIG. 11 is mounted on a user with a larger head (see, e.g., head 30 of FIG. 12, which is characterized by a front-to-rear distance D2 that is larger than D1), wires 34 tend to straighten out and cause masses 36 to rest at a position that is somewhat forward from the rear of head 30. Due to this more forward position, the distance between masses 36 and connection 22 is prevented from becoming too large and the lever arm effect of masses 36 is thereby prevented from becoming too large when counterweight 32 is mounted on larger heads. This arrangement therefore helps ensure that the counterbalancing performance of counterweight 32 will be relatively consistent and independent of user head size. FIG. 13 shows how counterweight 32 may have a tubular housing such as tube 84 that covers and guides wires 34 and masses 36.

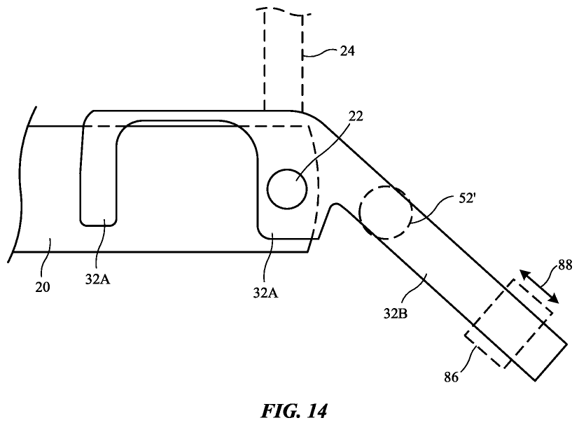

If desired, counterweight 32 may be configured to clip on to extension 20. Counterweight 32 may, for example, have a first portion (e.g., a slightly flexible plastic portion such as portion 32A that can clip over extension 20) and an extending portion such as shaft portion 32B (sometimes referred to as a shaft or elongated portion) that contains a counterweight mass or to which a sliding user-positionable mass such as mass 86 may be slidably attached. The user may adjust the counterweight effect of counterweight 32 by sliding mass 86 to a desired position along the length of portion 32B as shown by arrows 88. Optional clutch 52′ may be used to allow the angle of extending portion 32B to be adjusted relative to portion 32A. Overhead strap 24 may, if desired, be formed as an integral portion of counterweight 32 of FIG. 14.

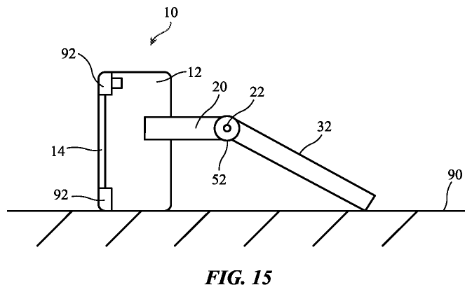

FIG. 15 is a side view of an illustrative head-mounted device in which adjustable counterweight 32 has been positioned to serve as part of a supporting stand for device 10. As shown in FIG. 15, the angular orientation of counterweight 32 may be adjusted about connection 22 relative to extensions 20 using clutch 52. When the position of housing 12 on a surface 90 such as a tabletop or other surface is adjusted in this way, a pair of left and right stereoscopic forward-facing cameras 16 (which may, for example, operate through openings in display bezel 92 of display 14) may be used to capture three-dimensional images or other image content. Three-dimensional video images may be displayed on display 14. These may be images from cameras 16 of device 10 or from comparable cameras in a remote companion version of device 10 that is gathering remote video for a video conference. Bezel 92 may help protect the edge of display 14 from damage when housing 12 is resting on surface 90.

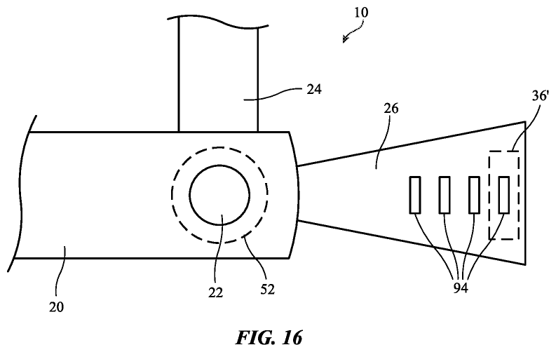

If desired, counterweight mass may be incorporated into rear strap (band) 26, so that band 26 serves as a counterweight. In the example of FIG. 16, a magnet in counterweight mass 36′ is being used to attach mass 36′ to one of multiple corresponding magnets 94 in strap 26 to adjust the forward-rearward position of mass 36′ and thereby adjust the counterweight effect of counterweight mass 36′. In this type of arrangement, strap 26 is sufficiently rigid to transfer counterweight torque to extension 20 via connection 22. Overhead strap 24 may be formed as an integral part of strap 36 or may be separately attached and detached from connection 22. One or more clutches (e.g., clutch 52) may be incorporated into connection 22 to allow the rotational position of strap 24 and/or the rotational position of strap 26 about connection 22 to be adjusted by the user.

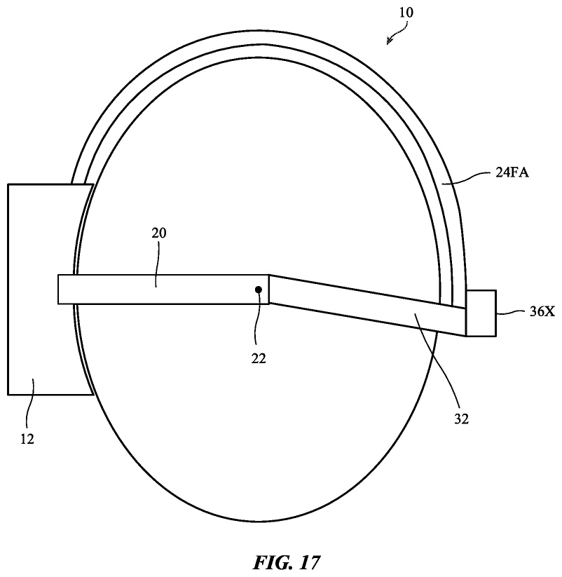

FIG. 17 is a side view of device 10 in an illustrative configuration in which device 10 has a forward-rearward overhead strap such as strap 24FA. One end of strap 24FA may be connected to housing 12 and another end of strap 24FA may be connected to counterweight 32. Counterweight 32 may have a mass such as mass 36X. Mass 36X may be moved along a shaft or wire in counterweight 32 or may otherwise be positioned to adjust the amount of counterbalancing produced by counterweight 32.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device, comprising:
a head-mounted housing having a rigid portion;
an overhead strap coupled to the rigid portion; and
an adjustable counterweight that is attached to the rigid portion and configured to counterbalance the head-mounted housing.

2. The head-mounted device defined in claim 1 further comprising a clutch that is configured to adjust a rotational orientation of the adjustable counterweight relative to the rigid portion.

3. The head-mounted device defined in claim 2 wherein the adjustable counterweight has an elongated support and a counterweight mass slidably coupled to the elongated support.

4. The head-mounted device defined in claim 3 wherein the elongated support comprises a wire attached to the clutch.

5. The head-mounted device defined in claim 4 wherein the counterweight mass comprises a channel configured to receive the wire.

6. The head-mounted device defined in claim 3 wherein the elongated support comprises a shaft attached to the clutch.

7. The head-mounted device defined in claim 6 wherein the counterweight mass is configured to slide along the shaft to adjust torque on the rigid portion produced by the counterweight mass.

8. The head-mounted device defined in claim 1 further comprising a rear strap coupled to the rigid portion.

9. The head-mounted device defined in claim 1 further comprising a battery in the adjustable counterweight.

10. The head-mounted device defined in claim 1 further comprising a port in the rigid portion, circuitry in the adjustable counterweight, and a cable that connects the circuitry in the adjustable counterweight to the port.

11. The head-mounted device defined in claim 1 further comprising:
magnets configured to attach the adjustable counterweight to the rigid portion.

12. The head-mounted device defined in claim 1 wherein the rigid portion comprises an elongated rigid portion that extends rearwardly from the housing.

13. A head-mounted device, comprising:
a head-mounted housing having a rigid extension;
an overhead strap coupled to the rigid extension; and
a counterweight configured to rotate relative to the rigid extension and configured to counterbalance the head-mounted housing.

14. The head-mounted device defined in claim 13 wherein the head-mounted housing has first and second optical assemblies, each having a respective display and lens, wherein the counterweight has a portion forming a cover, and wherein the counterweight is rotatable between a first position in which the cover counterbalances the housing and a second position in which the cover overlaps the first and second optical assemblies.

15. The head-mounted device defined in claim 13 wherein the counterweight has an elongated portion and a counterweight mass slidably coupled to the elongated portion.

16. A head-mounted device comprising:
a head-mounted housing having a rigid extension;
an overhead strap coupled to the rigid extension; and
an adjustable counterweight coupled to the rigid extension, wherein the adjustable counterweight is configured to counterbalance the head-mounted housing with an adjustable amount of counterbalancing force.

17. The head-mounted device defined in claim 16 wherein the adjustable counterweight has a first portion coupled to the rigid extension and a second portion that moves relative to the first portion.

18. The head-mounted device defined in claim 17 wherein the second portion comprises a movable counterbalancing mass.

19. The head-mounted device defined in claim 18 wherein the first portion comprises a wire along which the counterbalancing mass slides to adjust the counterbalancing force.

20. The head-mounted device defined in claim 18 wherein the first portion comprises a shaft along which the counterbalancing mass slides to adjust the amount of counterbalancing.
